(19) United States
(12) Patent Application Publication
(10) Pub. No.: US 2005/0033627 A1
(43) Pub. Date: Feb. 10, 2005

(54) Evaluating effectiveness of promoting products and services using a web site

(76) Inventors: E. Timothy Thieme, Pottersville, NJ (US); Paul David Ivans, Chatham, NJ (US); Karl William Miller, Pittstown, NJ (US)

Correspondence Address: HARNESS, DICKEY & PIERCE, P.L.C., P.O. BOX 828, BLOOMFIELD HILLS, MI, 48303, US

(21) Appl. No.: 10/229,758

(22) Filed: Aug. 28, 2002

(51) Int. Cl. G06F 17/60

(52) U.S. Cl. 705/10

(57) ABSTRACT

A method is provided for assessing effectiveness of promoting products using an interactive marketing medium. The method includes: identifying a series of steps that characterize a purchase process for a product; presenting information about the product to a potential customer using the interactive marketing medium; and assessing attitude of the potential customer towards the product resulting from the information being received from the interactive marketing medium, such that the attitude of the potential customer is correlated with one or more steps of the purchase process.

### FIELD OF THE INVENTION

The present invention relates generally to promoting products over the Internet and, more particularly, to techniques for evaluating effectiveness of promoting products using a Web site.

### BACKGROUND OF THE INVENTION

Companies are spending more resources than ever promoting their products and services using interactive marketing medium, such as the Internet. It is readily apparent that the interactive nature of these medium enable companies to directly gather feedback from customers being reached by their various promotional activities.

However, techniques for determining the effectiveness of promotional activities administered via an interactive medium remains a challenging endeavor. For instances, companies may be interested in techniques for determining whether such promotional activities are in fact changing customer attitudes towards the promoted products. Companies may also be interested in techniques for assessing whether the promotional activities are increasing sales of the promoted products. Finally, companies may be interested in determining whether the resources used on the promotional activities are being spent in a cost effective manner.

Therefore, it is desirable to provide improved techniques for assessing the effectiveness of promoting products and services using an interactive marketing medium.

### SUMMARY OF THE INVENTION

In accordance with the present invention, a method is provided for assesing effectiveness of promoting products using an interactive marketing medium. The method includes: identifying a series of steps that characterize a purchase process for a product; presenting information about the product to a potential customer using the interactive marketing medium; and assessing attitude of the potential customer towards the product resulting from the information being received from the interactive marketing medium, such that the attitude of the potential customer is correlated with one or more steps of the purchase process.

In another aspect of the present invention, a method is provided for monitoring effectiveness of promoting products using a Web site having a plurality of Web pages. The method includes: identifying a series of steps that characterize a purchase process for a product; associating one or more of the Web pages with at least one step in the purchase process; presenting information about the product to customers using the Web site; and computing a measure indicative of customer interaction with said one or more of the Web pages, thereby monitoring the promotional effectiveness of said one or more Web pages in relation to the at least one step of the purchase process.

For a more complete understanding of the invention, its objects and advantages, reference may be had to the following specification and to the accompanying drawings.

### BRIEF DESCRIPTION OF THE DRAWINGS

FIG. 1 is a diagram of an exemplary interactive marketing medium in accordance with the present invention;

FIG. 2 is a flowchart depicting a method for assessing effectiveness of promoting products using an interactive marketing medium in accordance with the present invention;

FIG. 3 is a diagram illustrating the steps associated with a purchase process for a pharmaceutical product;

FIG. 4 is a flowchart depicting an exemplary method for assessing customer attitude towards a product;

FIG. 5 is a flowchart depicting a method for monitoring effectiveness of promoting products using a Web site in accordance with the present invention; and

FIG. 6 is a chart illustrating the computed measures of the present invention in relation to the purchase process for a pharmaceutical product.

### DETAILED DESCRIPTION OF THE PREFERRED EMBODIMENTS

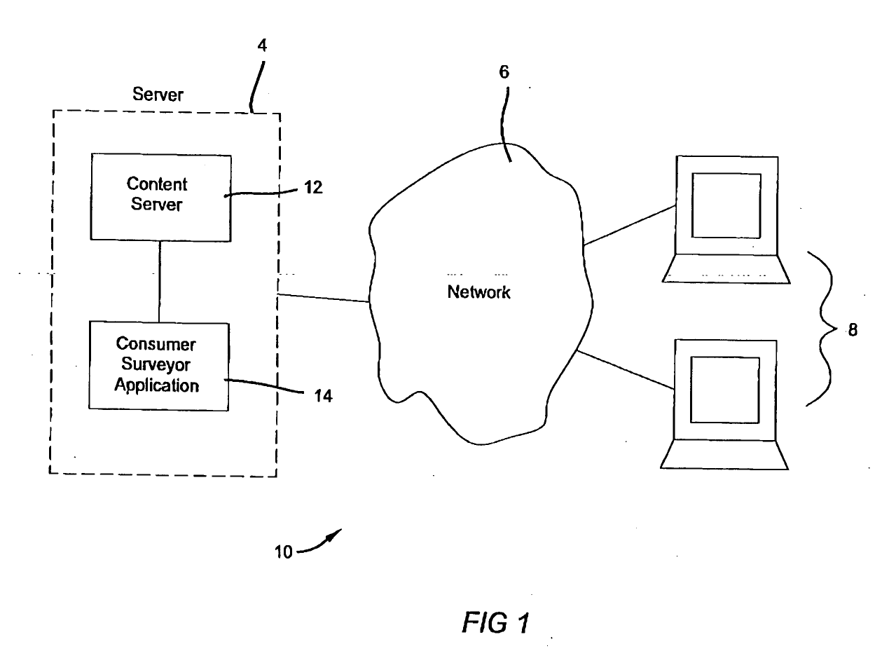

FIG. 1 illustrates an exemplary interactive marketing medium. In this exemplary embodiment, the interactive marketing medium is shown as a computer-implemented system 10, such as the Internet. While the following description is provided with reference to a computer-implemented system, it is readily understood that the broader aspects of the present invention are also applicable to other types of interactive marketing medium. For example, one skilled in the art will readily recognize how to adapt the teachings of the present invention to an interactive television system or other types of interactive broadcast medium.

The computer-implemented system 10 may include one or more server computing devices 4 interconnected by a network 6 to one or more client computing devices 8. In one exemplary embodiment, the client computing devices 8 are further defined as personal computers having a Web browser application. It is readily understood that the client computing devices may take other forms, such as a personal data assistant or a portable telephone, and may include other types of software applications adapted to retrieve information from the server computing devices 4. In this exemplary embodiment, the server computing devices 4 is further defined to include a content server 12, a customer surveyor application 14 and associated data stores. The content server 12 is configured to provide content data to requesting client computing devices 8 as is well known in the art. In accordance with the present invention, at least some of the content data is intended to promote various products or services. As will be further described below, the customer surveyor application 14 provides the means for assessing the effectiveness of promoting products or services over the computer-implemented system. For purposes of the following description, the term “product” is intended to refer to either a product or a service.

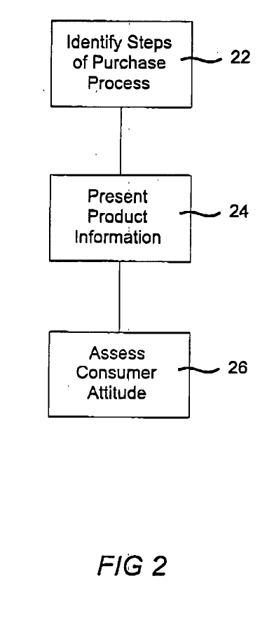

In accordance with the present invention, a first technique for assessing the effectiveness of promoting products using an interactive marketing medium is depicted in FIG. 2. First, the purchase process for a given product is characterized at step 22 by a series of steps that result in the customer purchasing the product. For illustration purposes, the product may be further defined as a pharmaceutical product. While the following description is provided with reference to a pharmaceutical product and its associated purchase process, it is readily understood that the present invention is applicable to other types of products and their associated purchase processes. The present invention is particularly suited to products having two or more decision makers involved in the purchase process and/or two or more steps in the purchase process.

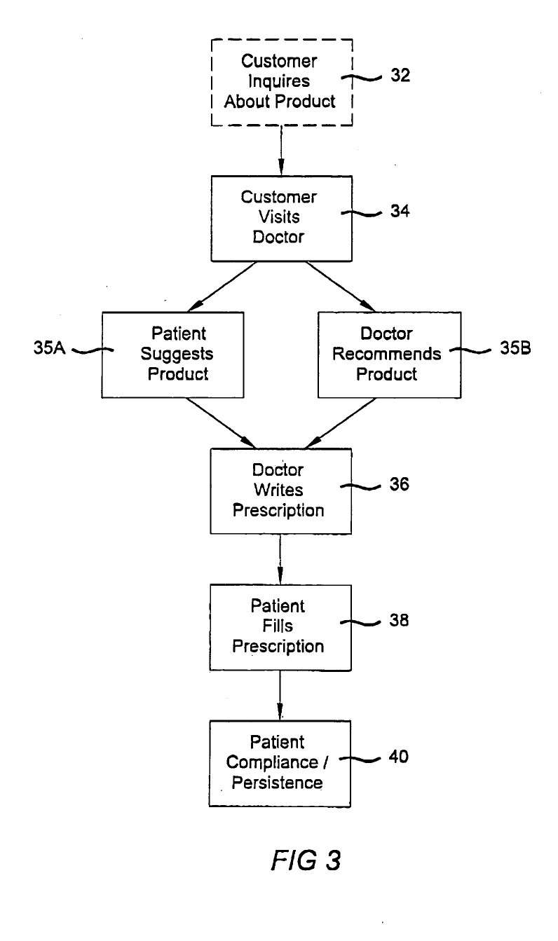

Referring to FIG. 3, the purchase process for a pharmaceutical product may involve up to six primary steps. First, a potential customer may inquiry 32 about a particular pharmaceutical product. This first step may involve researching the pharmaceutical product at a Web site provided by the product manufacturer and/or discussing the product with a friend, relative or co-worker who has or is using the product. In the context of the pharmaceutical product, a customer is typically viewed as the patient or person who uses the pharmaceutical product. However, it is envisioned that a customer generally includes, the patient, the healthcare professionals, such as doctors or nurses, who prescribes the product or otherwise treats the patient, as well as other persons who may influence the purchase process.

Next, the customer visits their doctor at step 34. During the visit, the potential customer may ask their doctor about a particular pharmaceutical product or ask their doctor to write a prescription for a particular pharmaceutical product as shown at step 35a. Alternatively, it is envisioned that the doctor may write a prescription for the pharmaceutical product without the potential customer having inquired about that particular product as shown at step 35b. In other words, the prescription may prescribed by the doctor in accordance with their diagnosis of the patient. In order to assess one or the other of these two situations, these steps may be individually identified.

In either case, the doctor then writes a prescription 36 for the pharmaceutical product. The customer in turn fills the prescription 38, thereby purchasing the product.

The purchase process may be extended based on the customer's compliance and persistence as shown at 40. Compliance involves the patient's diligence in following the prescription, such as taking the medication twice a day as prescribed; whereas persistency describes the patient's willingness to take the medication for the full length of their prescribed therapy which may include refills of the initial prescription. Compliance and persistency directly lead to additional purchases of the product by the customer. Conversely, if the customer is not satisfied with the product, they may request an alternative product from the doctor or merely discontinue using the product, thereby reducing product sales. Thus, it is apparent that the product manufacture may also be interested in this step of the overall purchase process.

Returning to FIG. 2, the customer is presented at step 24 with information relating to the product. For instance, the product manufacturer may provide a Web site at which potential customers can access information regarding various products. In the case of pharmaceutical products, the Web site may provide recommended dosages for a product, possible side affects from taking a product, advantages or benefits of the product as well as other information relating to the product. In this instance, the customer may view the product information on the Web site using a conventional Web browser residing on a personal computer as is well known in the art. One skilled in the art will readily recognize that the content and form of product information may vary within the scope of the present invention.

The attitude of the customer towards the product is then assessed at step 26. Particular attention is directed to the customer's attitude resulting from the information received by the customer from the interactive marketing medium. As further described below, the interactive medium is used to present the customer a series of questions designed to gage the customer's attitude towards the product. Of particular importance, the attitudes and views of the customer towards the product are correlated with one or more of the steps in the purchase process.

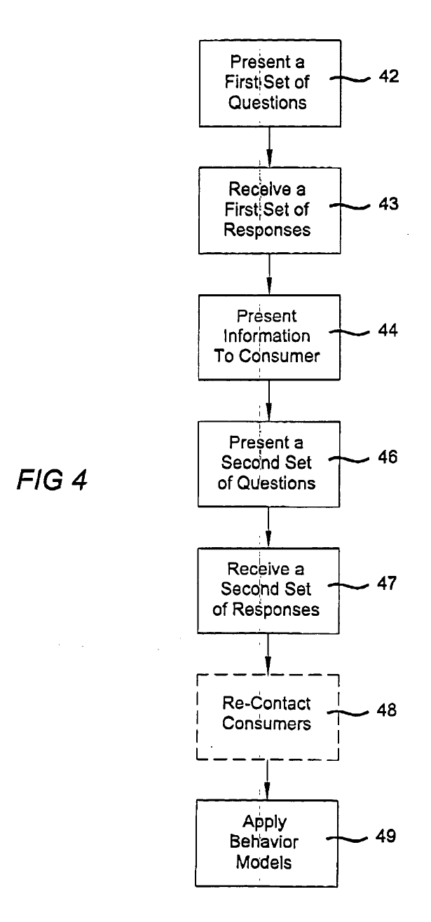

An exemplary method for assessing customer attitude towards a product is described in relation to FIG. 4. Prior to presenting information about the product, potential customers may be presented with a survey relating to the product. For instance, a pop-up dialog box may be presented to randomly selected visitors as they access a manufacturer's Web site. The selected visitors are then asked if they would like to participate in a brief survey.

If the visitors agrees to participate, they are presented a set of questions through a series of dialog boxes as shown at step 42. At least some of the questions are designed to gage the customer's attitude towards a particular product. Although the invention is not limited thereto, exemplary questions may include: are you visiting the Web site for yourself or someone else?; are you currently taking the product?; have you received a prescription for the product but have not yet taken it?; are you looking for more information about the product before deciding what to do?; and how likely are you to return to your doctor or health care professional to refill your prescription?

At least some of the questions are intended to gage the customer's attitude in relation to one of the steps of the purchase process. For instance, asking a customer how likely they are to refill their prescription for the product provides insight into the compliance step of the purchase process. One skilled in the art will readily recognize that other types of questions are within the scope of the present invention. Each of the visitor's responses to the questions are captured at step 43, thereby resulting in a set of responses that correlate to the set of questions. The set of responses are stored for subsequent analysis.

To assess any change in the customer's attitudes towards the product caused by the information received from the Web site, the customer may be presented a second set of questions as shown at step 46 after the customer has viewed the product information accessible on the Web site. To facilitate this process, the customer may have been asked during the first set of questions about their willingness to answer a few additional questions prior to leaving the Web site. If the customer expressed a willingness to do so, they are presented with a series of dialog boxes containing a second set of questions.

At least some of these questions are also designed to gage the customer's attitude towards the particular product. In addition, at least some of the questions may be designed to detect changes in the customer's attitude towards the product resulting from the information they viewed on the Web site. Exemplary questions may include: how well did the Web site address your need in relation to the product; or how likely are you to refill your prescription? Again, each of the customer's responses to the second set of questions are captured at step 47, thereby resulting in a second set of responses that correlate to the second set of questions. The second set of responses are also stored for subsequent analysis.

Customer attitude towards the product may then be assessed at step 49 based on the first and second sets of responses provided by one or more customers. To assess any changes in attitude resulting from the Web site, the customer's attitude as captured by the first set of responses may be compared to the customer's attitude captured by the second set of responses. It is to be understood that only the relevant steps of the methodology are discussed in relation to FIG. 4, but that other software-implemented instructions may be needed to control and manage the overall operation of the survey process.

Furthermore, customer behavior models may be applied to the survey results provided by one or more customers. Applying customer behavior models to the survey results yields information about the customer attitude towards a particular product, including but not limited to the likelihood that a particular customer may purchase the product. Customer behavior models and techniques for applying such models to survey results are generally known in the art.

To better assess customer attitude, it is envisioned that a product manufacturer may desire to verify and/or develop a customer behavior model based on data collected from its Web site visitors in relation to its own particular product or product line. To do so, the method for assessing customer attitude described above may be optionally modified as shown at step 48. To collect the data needed to construct a customer behavior model, potential customers are re-contacted by the manufacturer subsequent to them accessing the manufacturer's Web site. Although potential customers are preferably contacted via an email message, it is readily understood that other contact methods (e.g., a telephone call) may be used to contact the potential customers. As will be apparent to one skilled in the art, potential customers are asked one or more questions designed to determine the customer's behavior in relation to the manufacturer's product. Data collected in this manner may be used to construct a customer behavior model which may be applied to future survey results.

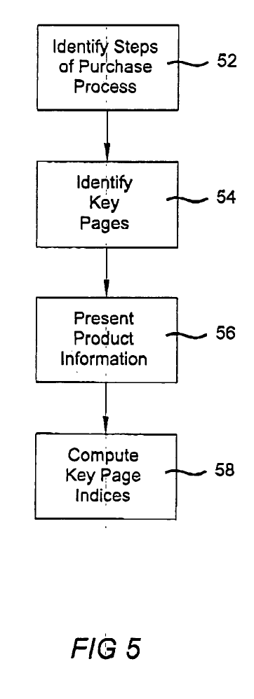

In another aspect of the present invention, a second technique for monitoring the effectiveness of promoting products using an interactive marketing medium is depicted in FIG. 5. This technique is particularly suited for an marketing medium having a plurality of discrete content segments. For illustration purposes, the technique will be further explained in relation to a Web site, such that the discrete content segments are Web pages associated with the Web site.

Initially, the purchase process for a given product is characterized by a series of steps 52 that result in the customer purchasing the product as described above. One or more Web pages are then. associated with at least one step of the purchase process as shown at 54. Such designated Web pages will be referred to as key pages. Although each of the key pages have some relation to the product and/or the purchase process, key pages should be particularly correlated to the designated step of the purchase process. For instance, a Web page describing the side affects for a pharmaceutical product is particularly influential on a potential customer who is considering asking their doctor to write a prescription for the product. Although not limited thereto, each step of the purchase process is preferably associated with at least one key page.

Next, the customer is presented at step 56 with information relating to the product via the Web site. Customer interaction with the key pages are then tracked over a predetermined period of time. Determining what pages are being view by customers and how long customers are spending on a particular Web page are readily known in the art.

To assess the promotional effectiveness of the key pages, one or more measures indicative of customer interaction with the key pages may be computed at step 58. In a preferred embodiment, the measures are further defined as a key page view index (KPVI) and a key page time index (KPTI). However, it is envisioned that other measures are within the scope of the present invention.

A key page view index indicates how often the key pages are being viewed in relation to the remainder of Web pages associated with the Web site. To compute the key page view index, a ratio is first determined for the number of times key pages are viewed and the total number of times all of the pages are viewed over a predetermined period of time. Second, a ratio is determined for the number of key pages and the total number of Web pages associated with the Web site. The key page view index is then computed by dividing the first ratio by the second ratio, thereby yielding a metric indicative of customer interaction with the key pages.

Similarly, a key page time index indicates how long the key pages are being view in relation to the remainder of Web pages associated with the Web site. To compute the key page time index, a ratio is first determined for the time spent viewing key pages and the total time spent viewing the Web site. Second, a ratio is determined for the number of key pages and the total number of Web pages associated with the Web site. The key page time index is then computed by dividing the first ratio by the second ratio, thereby yielding a metric indicative of customer interaction with the key pages. It is readily understood that larger index values indicate more customer interaction with the key pages.

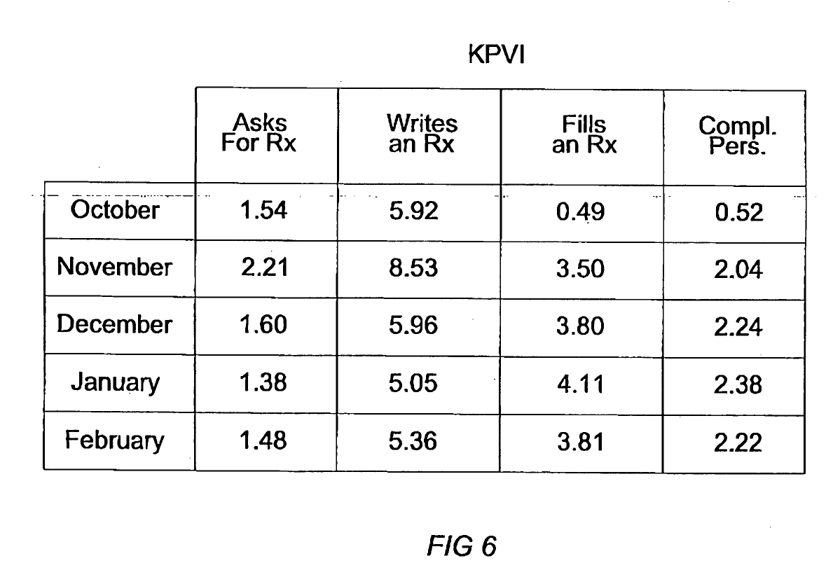

FIG. 6 illustrates the two exemplary indices in relation to the purchase process for a pharmaceutical product. Since key pages have been associated with steps of the purchase process, these indices provide insight into the effectiveness of the Web site in relation to the individual steps of the purchase process. For instance, the indices may prove out certain Web pages are frequently accessed by doctors, and thus are effectively assisting doctors who may in turn write prescriptions for the product. Alternatively, the indices may indicate that certain promotional activities designed to lure potential customers to the site are in fact failing to attract potential customers to the Web site.

It is envisioned that this monitoring technique may used in a variety of different ways. For instance, a product manufacturer may decide to spend x amount of dollars on a particular online promotional activities. The above-described technique may be used to determine the incremental change in the number of visitors to a particular key page and/or Web site resulting from the promotional activity. In addition, the amount spent may be correlated to the incremental change in product sales, thereby assessing the manufacturer's return on investment for the promotional activity. One skilled in the art will readily recognize that this technique for monitoring the effectiveness of promoting products may be used in conjunction with other assessment techniques, including those discussed herein.

In sum, the present invention provides significant advancement for determining the effectiveness of promotional activities supporting or related to an interactive marketing medium, such as a Web site. For instance, a product manufacturer could launch a banner advertising campaign directed to a specific customer base and then assess its effectiveness using one or more of the above-described techniques. In some instances, the promotional activities may be directed at particular step of an overall purchase process. Alternatively, the manufacturer may change navigation routes through the site or modify the content of the site and then assess these changes. Assessment results may in turn lead to different promotional activities or other activities relating to the Web site.

While the invention has been described in its presently preferred form, it will be understood that the invention is capable of modification without departing from the spirit of the invention as set forth in the appended claims.

1. A method for assessing effectiveness of promoting products using an interactive marketing medium having a plurality of content segments; comprising:
identifying a series of steps that characterize a purchase process for a product;
presenting information about the product to a potential customer using the interactive marketing medium; and
assessing attitude of the potential customer towards the product resulting from the information being received from the interactive marketing medium, such that a given attitude of the potential customer is correlated with one or more steps of the purchase process.

2. The method of claim 1 wherein the interactive marketing medium is further defined as a Web site, such that the plurality of content segments are a plurality of Web pages associated with the Web site.

3. The method of claim 1 wherein the product is further defined as a pharmaceutical product, such that the step of identifying a series of steps that characterize the purchase process results in a first step in which a potential customer visits a doctor, a second step in which the doctor writes a prescription for the pharmaceutical product, a third step in which a patient fills the prescription, and a fourth step in which the patient complies with the prescription.

4. The method of claim 1 wherein the step of assessing attitude is further defined as:
presenting a first set of questions to the potential customer, the first set of questions designed to gage the customer's attitude towards a particular product;
receiving a first set of responses to the first set of questions from the potential customer prior to presenting information about the product to the potential customer;
presenting a second set of questions to the customer after presenting information about the product to the potential customer, the second set of questions designed to gage the customer's attitude towards the product;
receiving a second set of responses to the second set of questions from the customer; and
assessing change in the customer's attitude towards the product based on the first and second set of responses provided by the customer.

5. The method of claim 4 wherein the step of presenting a first set of questions further comprises providing at least one question that is intended to gage a customer's attitude towards the product in relation to at least one step of the purchase process.

6. The method of claim 4 wherein the step of assessing attitude of the customer further comprises comparing at least some of the responses from the first set of responses with at least some of the responses from the second set of questions.

7. The method of claim 4 wherein the step of assessing attitude of the customer further comprises applying a customer behavior model to the first and second set of responses.

8. The method of claim 7 wherein the step of assessing attitude of the customer further comprises presenting a third set of questions to the potential customer using a secondary medium which is independent from the interactive marketing medium.

9. The method of claim 8 further comprises verifying the customer behavior model based on response received to the third set of questions.

10. The method of claim 8 further comprises constructing a customer behavior model based on response received to the third set of questions.

11. A method for assessing effectiveness of promoting products using a Web site having a plurality of Web pages; comprising:
identifying a series of steps that characterize a purchase process for a product;
associating one or more of the Web pages with at least one step in the purchase process, the designated Web pages providing information about the product;
presenting information about the product to customers using the Web site; and
computing a measure indicative of customer interaction with said one or more of the Web pages, thereby assessing the promotional effectiveness of said one or more Web pages in relation to said one step of the purchase process.

12. The method of claim 11 wherein the product is further defined as a pharmaceutical product, such that the step of identifying a series of steps that characterize the purchase process results in a first step in which a potential customer visits a doctor, a second step in which the doctor writes a prescription for the pharmaceutical product, a third step in which a patient fills the prescription, and a fourth step in which the patient complies with the prescription.

13. The method of claim 11 wherein the step of computing a measure further comprises formulating a key page view index indicative of the frequency at which customers view the designated Web pages in relation to remainder of Web pages associated with the Web site.

14. The method of claim 11 wherein the step of computing a measure further comprises formulating a key page time index indicative of the duration of time spent by customers viewing the designated Web pages in relation to the duration of time spent by customers viewing the remainder of Web pages associated with the Web site.

15. The method of claim 11 further comprises associating at least one Web page with each step of the purchase process and computing a measure indicative of customer interaction for each set of designated Web pages, thereby determining a measure that correlates to each step of the purchase process.

16. The method of claim 11 further comprises assessing attitude of the potential customer towards the product resulting from the information being received from the Web site.

17. A method for assessing customer attitude towards products viewed on a Web site, comprising:
presenting a first set of questions to a customer, the first set of questions designed to gage the customer's attitude towards a particular product;
receiving a first set of responses to the first set of questions from the customer;
presenting information associated with the product to the customer using the Web site;
presenting a second set of questions to the customer, the second set of questions designed to gage the customer's attitude towards the product;
receiving a second set of responses to the second set of questions from the customer; and
assessing attitude of the customer towards the product based on the first and second set of responses provided by the customer.

18. The method of claim 17 wherein the step of presenting a first set of questions further comprises providing at least one question that is intended to gage a customer's attitude towards the product in relation to at least one step of the purchase process.

19. The method of claim 17 wherein the step of assessing attitude of the customer further comprises comparing at least some of the responses from the first set of responses with at least some of the responses from the second set of questions.

20. The method of claim 17 wherein the step of assessing attitude of the customer further comprises applying a customer behavior model to the first and second set of responses.

21. The method of claim 20 further comprises presenting a third set of questions to the potential customer using a secondary medium which is independent from the Web site.

22. The method of claim 21 further comprises verifying the customer behavior model based on response received to the third set of questions.

23. The method of claim 21 further comprises constructing a different customer behavior model based on response received to the third set of questions.

24. A method for assessing effectiveness of promotional activities in relation to the purchase process for a product, comprising:
identifying a series of steps that characterize a purchase process for a product;
applying a promotional stimulus to at least one step in the purchase process, the promotional stimulus being designed to influence a person associated with said step of the purchase process; and
computing a measure indicative of the effectiveness of the promotional stimulus applied to said step of the purchase process.

25. The method of claim 24 wherein the purchase process having at least two persons whose assent is needed to complete a purchase of the product.

26. The method of claim 24 wherein the purchase process having at least two person involved in a decision to purchase the product, such that each of said two persons are associated with different steps in the purchase process.

27. The method of claim 24 wherein the step of applying a promotional stimulus further comprises presenting information about the product to a potential customer using the interactive marketing medium.

28. The method of claim 24 wherein the product is further defined as a pharmaceutical product, such that the step of identifying a series of steps that characterize the purchase process results in a first step in which a potential customer visits a doctor, a second step in which the doctor writes a prescription for the pharmaceutical product, a third step in which a patient fills the prescription, and a fourth step in which the patient complies with the prescription.
